(19) United States
(12) Patent Application Publication
(10) Pub. No.: US 2013/0209690 A1
(43) Pub. Date: Aug. 15, 2013

(54) METHOD FOR THE CORROSION-INHIBITING COATING OF METAL SURFACES USING PHOSPHORUS-CONTAINING POLYESTER

(71) Applicants: Rafael Bautista Mester, Munster (DE); Alexandra Steffens, Munster (DE)

(72) Inventors: Rafael Bautista Mester, Munster (DE); Alexandra Steffens, Munster (DE)

(73) Assignee: BASF Coatings GmbH, Munster (DE)

(21) Appl. No.: 13/812,910

(22) PCT Filed: Jul. 20, 2011
(86) PCT No.: PCT/EP2011/062480

§ 371 Date: Mar. 7, 2013

(30) Foreign Application Priority Data
Jul. 29, 2010 (DE) 10 2010 032 787.5

(51) Int. Cl. B05D 3/10

(52) U.S. Cl. CPC B05D 3/102
USPC 427/327

(57) ABSTRACT

The invention relates to a method for the corrosion-inhibiting coating of metal surfaces, which in a first step involves cleaning the metal surface and optionally treating it with a pretreatment composition and in a second step involves coating the metal surface cleaned and optionally pretreated in step (1) with a primer (P) which comprises at least one binder (BM) and at least one crosslinking agent (V), and also at least one phosphorus-containing polyester component (A), (A) being an acidic esterification product of phosphonic acid, of monophosphoric acid and/or of polyphosphoric acid, and/or of the anhydrides thereof and/or of the esters thereof, with at least one polyester (B) which contains at least two hydroxyl groups.

The present invention relates to a new method for the corrosion-inhibiting coating of metal surfaces which have been cleaned and optionally treated with a pretreatment composition. In order to obtain firmly adhering, corrosion-inhibiting coatings on coils or metal strips, especially those of the customary and known utility metals, such as zinc, aluminum or bright, galvanized, electrolytically zinc-coated, and phosphated steel, by means of the coil coating process (Römpp Lexikon Lacke and Druckfarben, Georg Thieme Verlag, Stuttgart, New York, 1998, page 617, “roll coating”, and page 55, “coil coating”), it is generally necessary to subject the surface of the coils to a pretreatment. In the context of the coil coating process, however, this represents an additional step, which it would be desirable to eliminate on economic and technical grounds.

Primer layers, as is known, serve to promote adhesion between the metal surface and the coatings lying over it. They may also make a certain contribution to corrosion control. They are typically produced from binder-containing, pigmented, and solvent-containing, thermally curable coating materials, which are optimized either in terms of their adhesion promotion or in terms of their contribution to corrosion control.

For producing corrosion-inhibiting coatings it is preferred to use phosphorus-containing coating compositions. Employed particularly in this context are coating compositions comprising binders and/or additives with phosphoric or phosphonic acid groups, since these constituents ensure particularly good corrosion control on untreated or inadequately pretreated metal surfaces.

WO 02/24973 A2 describes additives for coating compositions which serve for phosphating metal surfaces and comprise glyceryl phosphate. The phosphating agents of WO 02/24973 A2 do not contain binder and are therefore of only very limited suitability as adhesion promoters between metal substrate and overlying coats. Generally speaking, metal surfaces phosphated in this way are recoated with a separate primer layer for promoting adhesion, before the topcoat is applied.

WO 2005/000575 A1 describes pretreatment compositions for specific oxidized metal surfaces, which are employed more particularly for the immobilization of bioactive materials, and which comprise low molecular mass, acidic phosphoric esters HO₂POR₁OR₂ or phosphonic esters HO₂PR₁OR₂, in which the esters groups R₁ and/or R₂ may be aliphatic or aromatic units having 2 to 40 carbon atoms, which in turn may also carry further functional groups. The pretreatment compositions of WO 2005/000575 A1 do not contain binder and are therefore of only very limited suitability as adhesion promoters between metal substrate and overlying coats.

WO 2005/056697 A1 describes radiation-curable coating compositions which comprise acidic esters of monophosphoric or polyphosphoric acid whose ester radicals contain radiation-curable groups. These coating compositions are used preferably as primers in coil coatings and feature good substrate adhesion and intercoat adhesion. Disadvantages of these coating compositions are that the coil-coating line must include sources of actinic radiation and that the line speed of the coil coating process must be matched—a complicated procedure—to the power of these radiation sources.

WO 2007/020220 A1 describes thermally curable primers for coil coatings that comprise a corrosion inhibitor polymer which as comonomer units may comprise ethylenically unsaturated monomers having phosphonic or phosphoric acid groups.

These coating compositions feature good corrosion control properties and substrate adhesion, but the preparation of the aforementioned corrosion inhibitor polymers is costly and complicated.

WO 2008/017647 A1 describes thermally curable primers for coil coatings that comprise a phosphinic acid derivative as corrosion inhibitor component, it being possible for the phosphinic acid derivative HO₂P R₁R₂ to have alkyl radicals R₁ and/or R₂ having 1 to 30 carbon atoms, which may be functionalized with hydroxyl groups.

These coating compositions feature good corrosion control properties and substrate adhesion, but the preparation of the aforementioned corrosion inhibitor polymers is costly and complicated.

Problem and Solution

The problem addressed by the present invention, accordingly, was that of providing a new, thermally curable coating material and a process for its application that, particularly in the context of the use of the coating material as a primer in the coil coating process, no longer exhibits the disadvantages of the prior art, but results instead in good substrate adhesion and good corrosion control in conjunction with good intercoat adhesion. Moreover, the primer used in accordance with the process, and more particularly the corrosion-inhibiting component, ought to be easy to prepare, to be stable on storage, and to be capable of particularly easy and trouble-free application more particularly as part of the coil coating process. The new process ought specifically to result in primer coatings which, even on unpretreated metal surfaces, exhibit particularly high adhesion in combination with good corrosion control, more particularly on the surface of utility metals, such as zinc, aluminum or bright, galvanized, electrolytically zinc-coated, and phosphated steel, in conjunction with particularly high intercoat adhesion to the coatings situated above it, and which feature outstanding corrosion control effect, also in a coating system, particularly with respect to white corrosion, and which exhibit high elasticity, even in thin coats.

Found accordingly has been a process for the corrosion-inhibiting coating of metal surfaces, which in a first step (1) involves cleaning the metal surface and optionally treating it with a pretreatment composition and in a second step (2) involves coating the metal surface cleaned and optionally pretreated in step (1) with a primer (P), comprising at least one binder (BM) and at least one crosslinking agent (V), and also a corrosion-inhibiting component (A), (A) being an acidic esterification product of phosphonic acid, monophosphoric acid and/or polyphosphoric acid, more particularly polyphosphoric acid, and/or of anhydrides thereof and/or of esters thereof, with at least one polyester (B) which contains at least two hydroxyl groups.

In light of the prior art it was surprising and unforeseeable for the skilled worker that the problem addressed by the present invention could be achieved by means of the process of the invention.

In particular, primer coats produced with the process of the invention exhibited particularly high substrate adhesion and corrosion control effect, more particularly on the surface of utility metals, such as zinc, aluminum or bright, galvanized, electrolytically zinc-coated, and phosphated steel, in conjunction with particularly high intercoat adhesion to the coatings situated above it, outstanding corrosion control effect, in a coat system as well, particularly with respect to white corrosion, and high elasticity.

### DESCRIPTION OF THE INVENTION

The Corrosion-Inhibiting Component (A)

The primer (P) used in the process of the invention comprises at least one phosphorus-containing, corrosion-inhibiting component (A), (A) being an acidic esterification product of phosphonic acid, phosphoric acid and/or polyphosphoric acid, more particularly polyphosphoric acid, and/or of anhydrides thereof and/or of esters thereof, with at least one polyester (B) which contains at least two hydroxyl groups.

The polyphosphoric acid preferably used includes an arithmetic diphosphoric acid content which is preferably 70% to 95%, more preferably 70% to 90%, and more particularly 75% to 86%, by weight.

Based on its total amount, the phosphorus-containing component (A) contains preferably 1% to 20% and more particularly 2% to 15% by weight of phosphorus.

The preferably linear polyesters (B) that are suitable for the synthesis of the corrosion-inhibiting component (A) are, more particularly, condensates of low molecular mass dicarboxylic acids and dialcohols.

Examples of suitable dicarboxylic acids include aliphatic dicarboxylic acids such as succinic acid, glutaric acid, adipic acid, azelaic acid, sebacic acid, dodecanedioic acid, aliphatic dicarboxylic acids such as, for example, dimer fatty acids, i.e., reaction products of unsaturated fatty acids with one another, cycloaliphatic dicarboxylic acids such as 1,4- or 1,3-cyclohexanedicarboxylic acid, tricyclodecanedicarboxylic acid, and aromatic dicarboxylic acids such as isophthalic acid, terephthalic acid or phthalic acid. It will be appreciated that it is also possible to use derivatives of dicarboxylic acids, such as esters and/or anhydrides of carboxylic acids, for example. Particularly suitable are the aforementioned aliphatic dicarboxylic acids or mixtures thereof. Especially preferred are dicarboxylic acids which have carboxyl groups in α and ω positions on the longest carbon chain, such as azelaic acid, sebacic acid, and, more particularly, succinic acid, glutaric acid, and adipic acid, or mixtures thereof.

Examples of suitable dialcohols include aliphatic dialcohols such as, for example, ethylene glycol, diethylene glycol, triethylene glycol, propylene glycol, 1,3-butanediol, 1,3-propanediol, 1,4-butanediol, 1,6-hexanediol, 1,8-octanediol, neopentylglycol, 1-methylpropane-1,3-diol, 2-butyl-2-ethylpropanediol, pentanediols, hexanediols, octanediols, dodecanediol, neopentylglycol hydroxypivalate, cycloaliphatic alcohols such as 1,4- or 1,3-cyclohexanedimethanol, TCD alcohol, and bis(4-hydroxycyclohexyl)methane and -propane, and dimer diols (hydrogenated dimer fatty acids). It will be appreciated that it is also possible, conventionally, to use derivatives of alcohols, such as esters, for example, more particularly the corresponding methyl esters or ethyl esters. Particularly suitable are aliphatic dialcohols which have hydroxyl groups in α and ω positions on the longest carbon chain, such as ethylene glycol, 1,4-butanediol, and, more particularly, 1,6-hexanediol, 1,4-cyclohexanedimethanol or mixtures thereof.

Besides linear polyesters (B) it is also possible to use branched polyesters (B). Suitable monomers for producing branches include tricarboxylic acids or their anhydrides such as trimellitic anhydride or trimesic acid and trialcohols such as trimethylolalkanes—examples being trimethylolethane or trimethylolpropane.

The OH number (OHN) to DIN 53240 of the polyesters used as component (B) is generally about 50 to 500 mg KOH/g, preferably 100 to 450 mg KOH/g, more preferably 150 to 400 mg KOH/g.

The acid number (AN) to DIN 53402 of the polyesters used as component (B) is generally less than 20 mg KOH/g, preferably less than 10 mg KOH/g, more preferably less than 5 mg KOH/g.

The number-average molecular weights Mn of the polyesters used as component (B) is typically 200 to 2000 g/mol, preferably 250 to 1500 g/mol, and more preferably 300 to 1000 g/mol. The number-average molecular weights Mn can be determined by colligative methods such as, for example, cryoscopy, membrane or vapor-pressure osmometry, and are ascertained preferably—where the number of end groups per molecule is known—by end group determination.

The corrosion-inhibiting component (A) is prepared preferably by esterifying the phosphonic acid, phosphoric acid and/or polyphosphoric acid, more particularly phosphoric acid, and/or the anhydrides thereof and/or the esters thereof, with the polyester (B) in a manner such that the esterification product still has free acid groups. It is especially preferred to use the aforementioned polyphosphoric acid, or its anhydride, with component (B) being used preferably in a molar ratio of 1:3 to 3:1, based on the phosphate units, more particularly in a molar ratio of 1:2 to 2:1.

The corrosion-inhibiting component (A) is present in the primer (P) preferably in fractions of 1% to 25% by weight, based on the solids content of the primer (P), more particularly in fractions of 2% to 20% by weight.

The Further Constituents of the Primer (P)

The Binder (BM) in the Primer (P)

The binder component may be composed of one or more binders (BM). To a skilled worker it is general knowledge which binders (BM) are suitable. Binders (BM) particularly suitable for use in the context of coil coating are, as described in WO 2007/020220 A1, for example, (meth)acrylate (co)polymers, partially hydrolyzed polyvinyl esters, polyesters, alkyd resins, polylactones, polycarbonates, polyethers, epoxy resins, which may also be liquid or may contain liquid constituents, epoxy resin-amine adducts, polyureas, polyamides, polyimides or polyurethanes. It will be appreciated that mixtures of different binders (BM) can be used, provided the mixing causes no unwanted effects.

It is preferred to use polyesters as binders (BM). Suitable polyesters are, more particularly, condensates of low molecular mass dicarboxylic acids and dialcohols. Examples of suitable dicarboxylic acids include aliphatic dicarboxylic acids such as adipic acid, azelaic acid, sebacic acid, dodecanedioic acid, aliphatic dicarboxylic acids such as, for example, dimer fatty acids, i.e., reaction products of unsaturated fatty acids with one another, cycloaliphatic dicarboxylic acids such as 1,4- or 1,3-cyclohexanedicarboxylic acid, tricyclodecanedicarboxylic acid, and aromatic dicarboxylic acids such as isophthalic acid, terephthalic acid or phthalic acid. It will be appreciated that it is also possible to use derivatives of dicarboxylic acids. Particularly suitable are anhydrides such as, for example, phthalic anhydride, hexahydrophthalic anhydride or tetrahydrophthalic anhydride.

Examples of suitable dialcohols include aliphatic alcohols such as, for example, ethylene glycol, diethylene glycol, triethylene glycol, propylene glycol, 1,3-butanediol, 1,3-propanediol, 1,4-butanediol, neopentylglycol, 1-methylpropane-1,3-diol, 2-butyl-2-ethylpropanediol, pentanediols, hexanediols, octanediols, dodecanediol, neopentylglycol hydroxypivalate, cycloaliphatic alcohols such as 1,4- or 1,3-cyclohexanedimethanol, TCD alcohol, and bis(4-hydroxycyclohexyl)methane and -propane, and dimer diols (hydrogenated dimer fatty acids). It will be appreciated that it is also possible, conventionally, to use derivatives of alcohols, such as esters, for example, more particularly the corresponding methyl esters or ethyl esters. Besides linear polyester binders (BM) it is also possible to use branched polyester binders (BM). Suitable monomers for introducing branches include tricarboxylic acids or their anhydrides such as trimellitic anhydride or trimesic acid and trialcohols such as trimethylolalkanes—examples being trimethylolethane or trimethylolpropane.

The OH number (OHN) of the polyesters used as binders (BM) is generally about 5 to 200 mg KOH/g, preferably 10 to 120 mg KOH/g, more preferably 12 to 80 mg KOH/g and, for example, about 20 mg KOH/g. The number-average molecular weights Mn of the polyesters used as binders (BM) is typically 500 to 10 000 g/mol, preferably 1000 to 8000 g/mol, and more preferably 2000 to 6000 g/mol.

The preferred binder is a polycondensate of a mixture of aromatic diacids such as isophthalic acid, ortho-phthalic acid, and terephthalic acid, and aliphatic diols such as ethylene glycol, di- and/or polyethylene glycol, and neopentylglycol.

The primer of the invention comprises 15% to 60%, preferably 20% to 50%, by weight of the binder (BM), based on the solids content of the primer (P). Suitable more particularly for the coil coating process is a 30% to 45% by weight fraction of binder (BM), based on the solids content of the primer (P).

The Crosslinking Agent (V) and the Other Components in the Primer (P)

Crosslinking agents (V) for the thermal crosslinking of the aforementioned polymers are known to the skilled worker.

For the crosslinking of the preferred hydroxyl-containing polymers it is preferred as crosslinking agents (V) to use melamine resins and/or amino resins. Especially preferred for the crosslinking of the preferred hydroxyl-containing polymers are melamine derivatives, such as hexabutoxymethylmelamine and more particularly the highly reactive hexamethoxymethylmelamine, and/or modified or unmodified amino resins. Crosslinking agents (V) of these kinds are available commercially (for example, as Luwipal® from BASF AG).

As crosslinking agents (V) for the preferred hydroxyl-containing polymers it is possible, furthermore, to use unblocked or blocked polyisocyanates, more particularly oligomers of diisocyanates, such as trimethylene diisocyanate, tetramethylene diisocyanate, pentamethylene diisocyanate, hexamethylene diisocyanate, heptamethylene diisocyanate, ethylethylene diisocyanate, trimethylhexane diisocyanate or acyclic aliphatic diisocyanates which contain a cyclic group in their carbon chain, such as diisocyanates derived from dimer fatty acids, of the kind sold under the trade name DDI 1410 by Henkel and described in patents WO 97/49745 and WO 97/49747. The latter, in the context of the present invention and on the basis of their two isocyanate groups attached exclusively to alkyl groups, are included among the acyclic aliphatic diisocyanates, in spite of their cyclic groups. Among the aforementioned diisocyanates, hexamethylene diisocyanate is used with particular preference. It is preferred to use oligomers which contain isocyanurate, urea, urethane, biuret, uretdione, iminooxadiazinedione, carbodiimide and/or allophanate groups.

In the blocking of the polyisocyanates, the isocyanate group is reacted with a blocking agent which is eliminated again on heating to higher temperatures. Examples of suitable blocking agents are described in, for example, DE-A-199 14 896, columns 12 and 13.

To accelerate the crosslinking it is preferred in a known way to add suitable catalysts.

Based on the nonvolatile fractions in the binder (BM), the fraction of the crosslinking agents (V) is preferably between 5% and 60%, more preferably between 10% and 50%, by weight, based on the binder (BM).

The primer (P) further comprises preferably inorganic fillers and/or inorganic color and/or effect pigments and/or conductive pigments. Pigments and fillers are described in WO 2007/020220 A1, for example. Conventional fillers, which serve in particular to level unevennesses in the substrate and/or to increase the impact strength of the coat produced from the primer (P), are preferably chalk, hydroxides such as aluminum hydroxides or magnesium hydroxides, and phyllosilicates such as talc or kaolin, with talc being particularly preferred.

Color and/or effect pigments used are preferably inorganic pigments, such as, more particularly, white pigments and black pigments. Preferred white pigments are silicon oxides, aluminum oxides, and, in particular, titanium oxides, and also barium sulfate. Preferred black pigments are iron oxides and, more particularly, graphite and carbon blacks.

As conductive pigments it is preferred to use phosphides, vanadium carbide, titanium nitride, and molybdenum sulfide. Additions of this kind serve, for example, to improve the weldability of the coating formed from the coating composition (B). As conductive pigments it is preferred to use metal phosphides of Zn, Al, Si, Mn, Cr, Ni or, in particular, Fe, as described in WO 03/062327 A1, for example. A particularly preferred conductive pigment used is zinc dust.

The fillers present in the primer (P) preferably have average particle diameters which do not exceed the thickness of the cured integrated pretreatment coat. The upper particle-size limit in the fillers, measured in accordance with EN ISO 1524:2002, is preferably less than 15 μm, more preferably less than 12 μm, and more particularly less than 10 μm. The inventively employed primer (P) contains preferably 10% to 80%, more preferably 15% to 70%, and more particularly 20% to 60%, by weight, of fillers, based on the nonvolatile constituents of the primer (P).

Besides the phosphorus-containing, corrosion-inhibiting component (A) of the invention, the primer (P) may comprise preferably inorganic anticorrosion pigments, such as, more particularly, aluminum phosphate, zinc phosphate, zinc aluminum phosphate, molybdenum oxide, zinc molybdate, calcium zinc molybdate, zinc metaborate or barium metaborate monohydrate. In one particularly preferred embodiment of the invention, anticorrosion pigments of this kind are used in combination with amorphous silicon dioxide that has been modified with metal ions. The metal ions are selected preferably from the group consisting of alkali metal ions, alkaline earth metal ions, lanthanide metal ions, and also zinc ions and aluminum ions, with calcium ions being particularly preferred. Amorphous silicon dioxide modified with calcium ions can be acquired as a commercial product under the brand name Shieldex® (Grace GmbH & Co. KG). Furthermore, constituents used in the anticorrosion pigment preparations may include dimeric, oligomeric or polymeric alkoxides of aluminum or titanium, optionally as adducts with phosphorus-containing compounds, as described in WO 03/062328 A1.

The anticorrosion pigments preferably have average particle diameters which do not exceed the thickness of the cured integrated pretreatment coat. The upper particle-size limit of the anticorrosion pigments, measured in accordance with EN ISO 1524:2002, is preferably less than 15 μm, more preferably less than 12 μm, and more particularly less than 10 μm. Furthermore, instead of or in addition to the aforementioned inorganic anticorrosion pigments, there may also be organic corrosion inhibitors, preferably low molecular mass and/or optionally polymeric corrosion inhibitors, present as additional corrosion control components. Particular preference is given to dicarboxylic acid mixtures, more particularly alkanedicarboxylic acid mixtures, preferably of C4, C5 and C6 dicarboxylic acids (an example being Sokolan DCS from BASF SE).

The amount of the solvents in the primer (P) will be chosen by the skilled worker in accordance with the desired properties of the inventive composition and the desired method of application. The composition may also first be prepared as a concentrate and diluted only on site to the desired concentration.

The skilled worker selects suitably from those solvents that are possible in principle, on the basis of operational conditions and the nature of the components employed. Examples of organic solvents which may be compatible with water include ethers, polyethers, such as polyethylene glycol, ether alcohols, such as butylglycol or methoxypropanol, ether glycol acetates, such as butylglycol acetate, methoxyisopropyl acetate, ketones, such as acetone, methyl ethyl ketone, alcohols, such as methanol, ethanol, propanol, and diacetone alcohol, and organic carbonates, such as propylene carbonate. Also used are hydrophobic solvents, such as, more particularly, benzine fractions and aromatic fractions, with such solvents being used more as additives for controlling specific film properties. The amount of the volatile constituents (BL) in the coating composition (B) may vary widely, with the ratio of volatile constituents (BL) to nonvolatile constituents of the coating composition (B) being generally between 10:1 and 1:10, preferably between 5:1 and 1:5, more preferably between 4:1 and 1:4.

The weight fraction of the volatile constituents (BL), relative to the total 20 weight of the primer (P), is 15% to 80%, preferably 20% to 70%, more preferably 30% to 60%, by weight.

The primer (P) may further comprise one or more auxiliaries and/or additives. Such auxiliaries and/or additives serve to fine-tune the properties of the coat. Their amount generally does not exceed 30% by weight, based on the total weight of the primer (P), and preferably the fraction does not exceed 20% by weight.

Examples of suitable adjuvants are color and/or effect pigments, reactive diluents for thermal curing or for curing with actinic radiation, rheological assistants, UV absorbers, light stabilizers, free-radical scavengers, free-radical polymerization initiators, thermal crosslinking catalysts, photoinitiators and photocoinitiators, slip additives, polymerization inhibitors, defoamers, emulsifiers, degassing agents, wetting agents, dispersants, adhesion promoters, flow control agents, film-forming assistants, rheology control additives (thickeners), flame retardants, siccatives, antiskinning agents, other corrosion inhibitors, waxes, and matting agents, of the kinds also known from the textbook “Lackadditive” by Johan Bieleman, Wiley-VCH, Weinheim, New York, 1998 or from German patent application DE-A 199 14 896, column 13 line 56 to column 15 line 54.

Suitable other corrosion inhibitors, which are generally used in addition to the phosphorus-containing, corrosion-inhibiting component (A), are described in WO 2007/020220 A1, for example, and may be selected from the group of phosphonic acids, amino phosphonates, organic and inorganic phosphates, examples being those of zinc, of calcium and of magnesium, vinylphosphonic acids and their salts, carboxylic acids and their salts and esters, alkanolamines and amines, benzotriazoles and structural derivatives thereof such as tolyltriazole, for example, acetylene derivatives, such as, for example, N,N-dimethyl-2-propyn-1-amine, N,N-diethyl-2-propyn-1-amine, 1,1-dimethyl-2-propynyl-1-amine, N,N-diethyl-4-amino-2-butyn-1-ol, 2,5-dimethyl-3-hexyne-2,5-diol, 3-hexyne-2,5-diol, 2-butyne-1,4-diol ethoxylate, 2-butyne-1,4-diol, 2-butyne-1,4-diol propoxylate, propargyl alcohol, propargyl alcohol ethoxylate, propargyl alcohol propoxylate, propynesulfonic acid and its salts, aldehydes, amine- and sodium-neutralized phosphoric esters of alkyl alcohols, amine carboxylates, aminophenols and nitrophenols, amino alcohols, aminobenzimidazole, aminoimidazolines, aminotriazole, benzimidazolamines, benzothiazoles, boric esters with different alkanolamines such as, for example, boric acid diethanolamine ester, butynediol, quinoline derivatives, dibenzyl sulfoxide, dicarboxylic acids and their esters, diisobutenylsuccinic acid, dithiophosphonic acid, fatty amines and fatty acid amides, guanidine derivatives, urea and its derivatives, laurylpyridinium chloride, maleamides, mercaptobenzimidazole, N-2-ethylhexyl-3-aminosulfopropionic acid, phosphonium salts, phthalamides, polyetheramines, sulfonium salts, sulfonic acids such as, for example, methanesulfonic acid, thioethers, thioureas, thiuram disulfides, cinnamic acid and derivatives thereof.

The coating composition (B) is prepared by intensely mixing the components with the solvents. Suitable mixing and dispersing assemblies are known to the skilled worker.

The Application and Conditioning of the Inventive Primer (P) and of the Subsequent Coats

In step (1) of the process of the invention, the metal surface to be coated is cleaned and optionally coated with a pretreatment composition. Where step (1) of the process takes place immediately after a metallic surface treatment, such as an electrolytic galvanization or hot-dip galvanization of the metal surface, for example, the primer (P) can generally be applied to the coil without preliminary cleaning. Where the coils to be coated are stored and/or transported prior to coating of the primer (P), they generally carry a coating of anticorrosion oils or else are otherwise contaminated, and so the coil needs to be cleaned before step (1) of the process. Cleaning may take place by techniques known to the skilled worker, using typical cleaning agents.

Application of the primer (P) to the coil may take place by spraying, pouring, or—preferably—rolling.

In the case of the preferred roll coating, the rotating pick-up roll dips into a reservoir of the primer (P) and in this way picks up the primer (P) to be applied. This primer is transferred from the pick-up roll, directly or via at least one transfer roll, to the rotating application roll. This roll transfers the primer (P) onto the coil by equidirectional or contrarotatory wiping. In accordance with the invention, contrarotatory wiping, or the reverse roller coating method, is advantageous and is employed with preference. The application roll preferably has a rotational speed which is 110% to 125% of the coil speed, and the pick-up roll preferably has a rotational speed which is 20% to 40% of the coil speed. The primer (P) can alternatively be pumped directly into a gap (nip) between two rolls, this also being referred to as a nip feed method.

The speed of the coil is chosen by the skilled worker in accordance with the drying and/or curing conditions for the primer (P) in step (2). Generally speaking, coil speeds of 10 to 200 m/min, preferably 12 to 160 m/min, more preferably 14 to 140 m/min, have been found appropriate. For the drying of the film formed from the primer (P) on the coil, in other words for removing the volatile constituents of the primer (P), the coil coated in step (1) is heated by means of a suitable device. Heating may take place by convective heat transfer, irradiation with near or far infrared radiation, and/or by electrical induction in the case of suitable metal substrates, more particularly iron. The solvent can also be removed by contacting with a gas stream, in which case a combination with the above-described heating is possible.

The drying and/or curing of the primer (P) is carried out preferably at peak temperatures occurring on the metal (peak metal temperature (PMT), which can be determined, for example, by noncontact infrared measurement or using temperature indicator strips), of at least 80° C., more preferably at least 100° C., and very preferably at least 120° C., more particularly at PMTS of between 120 and 300° C., preferably between 140 and 280° C., and more preferably between 150 and 260° C., with the speed of the coil and hence the residence time in the drying region of the coil-coating line being adjusted, in a manner known to the skilled worker, in such a way that it is possible to set a defined residual volatiles content in the film formed from the primer (P) on departure from the drying region.

The thickness of the dried film of the primer (P) produced in step (2) of the process is generally between 1 and 15 μm, preferably between 2 and 12 μm, more preferably between 3 and 10 μm.

Between the process steps (2) and the following process steps in the coil coating process, the coil provided with the dried film of primer (P) can be rolled up again and the further coat or coats can be applied not until a later point in time.

In the following steps of the coil-coating process, one or more topcoat materials (D) are applied to the dried film of primer (P) produced in step (2) of the process, suitable topcoat materials (D) including, in principle, all of the coating compositions that are suitable for coil coatings.

The topcoat material (D) may be applied by spraying, pouring or, preferably, by the above-described roll application.

It is preferred to apply a pigmented topcoat material (D) with high flexibility which provides not only coloring but also protection against mechanical exposure and also against effects of weathering on the coated coil.

Topcoat materials (D) of this kind are described in EP-A1-1 335 945 or EP-A1-1 556 451, for example. In another preferred embodiment of the invention, the topcoat materials (D) may comprise a two-coat system made up of a coloring basecoat and a final clearcoat. Two-coat topcoat systems of this kind that are suitable for coating coils are described in DE-A-100 59 853 and in WO-A-2005/016985, for example.

In a concluding step of the process, the film of primer (P), applied in step (2) of the process and dried, is cured, i.e., crosslinked, jointly with the film of topcoat (D) applied in the subsequent step, step (3), of the process; during this curing procedure, the residual moisture is removed from the dried film of primer (P) jointly with the solvent from the topcoat (D). The crosslinking is guided by the nature of the binders (BM) employed in the coating composition (B) and also of the binders employed in the topcoat film (D), and in general takes place thermally, in which case the coil coated by the process described above is heated by means of a suitable device. Heating may take place by irradiation with near or far infrared radiation, by electrical induction in the case of suitable metal substrates, more particularly iron, and, preferably, by convective heat transfer. The removal of the solvent can also be accomplished by contacting with a gas stream, in which case combination with the above-described heating is possible.

The temperature required for crosslinking is guided more particularly by the binders employed in the primer (P) and in the topcoat film (D). Crosslinking is carried out preferably at peak temperatures encountered on the metal (PMT) of at least 80° C., more preferably at least 100° C., and very preferably at least 120° C. More particularly the crosslinking is performed at PMTS of between 120 and 300° C., preferably between 140 and 280° C., and more preferably between 150 and 260° C.

The speed of the coil and hence the residence time in the oven region of the coil-coating line is preferably adjusted, in a manner familiar to the skilled worker, such that crosslinking in the film formed from the primer (P) and in the film formed from the topcoat (D) is largely complete on departure from the oven region. The duration for the crosslinking is preferably 10 seconds to 2 minutes. Where, for example, ovens with convective heat transfer are employed, then, in the case of the preferred coil speeds, forced-air ovens with a length of about 30 to 50 m are required. In this case the forced-air temperature is of course higher than the PMT and can be up to 350° C.

The thickness of the thus-produced coat system, comprising the cured coats based on the primer (P) and the cured coats based on the topcoat (D), is generally between 2 and 60 μm, preferably between 4 and 50 μm, more preferably between 6 and 40 μm.

The coat systems produced by the process of the invention may be applied more particularly to the surface of iron, steel, zinc or zinc alloys, such as zinc aluminum alloys, for example, such as Galvalume® and Galfan®, or zinc magnesium alloys, magnesium or magnesium alloys, aluminum or aluminum alloys.

Coils provided with the coat system produced by the process of the invention may be processed by means, for example, of cutting, forming, welding and/or joining, to form shaped metallic parts. The invention hence also provides shaped articles which have been produced with the inventively produced coils. The term “shaped articles” is intended to encompass not only coated metal panels, foils or strips but also the metallic components obtained from them.

Such components are more particularly those that can be used for paneling, facing or lining. Examples include automobile bodies or parts thereof, truck bodies, frames for two-wheelers, such as motorcycles or pedal cycles, or parts for such vehicles, such as fairings or panels, casings for household appliances, such as washing machines, dishwashers, laundry dryers, gas ovens, and electric ovens, microwave ovens, freezers or refrigerators, for example, casings for technical instruments or installations, such as machines, switching cabinets, computer housings or the like, for example, structural elements in the architectural sector, such as wall parts, facade elements, ceiling elements, window profiles, door profiles or partitions, furniture made from metallic materials, such as metal cupboards, metal shelves, parts of furniture, or else fittings. The components may also be hollow articles for the storage of liquids or other substances, such as, for example, tins, cans or tanks.

The examples which follow are intended to illustrate the invention.

### EXAMPLES

### Example 1

### Preparation of the Phosphorus-Containing Polyester Component A1 of the Inventive Coating Composition

A mixture of 36.5 parts by weight of dicarboxylic acid mixture (Sokolan DCS, manufactured by BASF SE), 27.8 parts by weight of hexanediol, and 35.6 parts by weight of cyclohexanedimethanol was charged to a stirred tank equipped with a water separator, and was heated at 230° C. with stirring under a nitrogen atmosphere. The water released was collected in a water separator. The reaction mixture was held at 230° C. until the acid number fell below a figure of 4 mg KOH/g. The resulting mixture had a solids fraction of 90% and a viscosity of 380 mPas (at 50° C.). The resulting polyester 1 had an acid number of 2.2 mg KOH/g to DIN 53402, an OH number of 280 mg KOH/g to DIN 53240, and a number-average molecular weight Mn of 400 g/mol.

In a stirred tank made from stainless steel, 80.1 parts by weight of polyester 1 were heated to 41° C. and 19.9 parts by weight of polyphosphoric acid 105 (manufacturer: Thermphos) were added dropwise over the course of 1.25 hours, during which the temperature increased to 46° C. The mixture was stirred at 46° C. for a further 4 hours.

The resulting component A1 had a viscosity of 36 Pas, a solids of 93%, and a phosphorus content of 6.6% by weight, based on A1.

### Example 2

### Preparation of the Inventive Coating Composition and of a Comparison Sample

The commercial coil-coating primer COILTEC® Top Universal P CF, comprising as polyester binders 24% by weight, based on the solids of the primer (P), of a mixture of URALAC SN905 (manufacturer: DSM) and liquid epoxy Araldite® GY 2600 (manufacturer: Huntsman), 5% by weight of melamine resin as crosslinker, color pigments, and corrosion inhibitors, was admixed with the phosphorus-containing polyester component A1 in an amount such that the resulting inventive coating composition had a phosphorus content of 0.6% by weight, based on the solids of the primer (P).

Used as comparison sample V1 was the unmodified coil-coating primer COILTEC® Top Universal P CF (manufacturer: BASF Coatings GmbH).

### Example 3

### Production and Testing of the Inventive Primer Coatings and Following Topcoats

Substrates used were degreased, unpretreated steel panels made from steel of grade Z (OEHDG 4, manufacturer: Chemetall). The coating material of example 2 and also the comparison sample V1 were applied to the substrates using coating rods in a wet film thickness such that curing in a forced-circulation dryer at a forced-air temperature of 365° C. and a panel temperature of 243° C. resulted in a dry film thickness of 5 μm.

The primer coatings were thereafter coated further with a commercial coil-coating topcoat (Polyceram® PlusP, manufacturer: BASF Coatings GmbH) based on polyester/melamine resin, in such a way that curing in a forced-circulation dryer at a forced-air temperature of 365° C. and a panel temperature of 243° C. resulted in a dry film thickness of 20 μm. This gave the coatings HB1 and VB1 (pretreatment-free combination of commercial coil-coating primer and commercial coil-coating topcoat). In a further comparative test, a coating VB2 was produced from the combination of commercial coil-coating primer and commercial coil-coating topcoat on a metal panel coated with a commercial pretreatment composition (Gardobond TP 10475, manufacturer: Chemetall GmbH).

Testing of the Coating Systems Composed of Coil-Coating Primer and Coil-Coating Topcoat:

The following testes were carried out on the resulting coat systems:

Tape test: The adhesion of the coat system made up of coil-coating primer and coil-coating topcoat on the substrate was determined in accordance with DIN EN ISO 13523-7.

Corrosion test (C test): In order to test the corrosion-inhibiting effect of the primer coatings, the coatings were scored and subjected to salt spray testing for 360 hours. The panels were inspected after the end of corrosion exposure. The parameter determined was the sub-film creep at the score mark, in mm, in accordance with DIN EN 13523 and DIN EN ISO 9227.

T-bend test: This test, for determining the flexibility of the coat system made up of coil-coating primer and coil-coating topcoat, was carried out in accordance with DIN EN 13523-7.

Results of the testing of the systems comprising coil-coating primers and coil-coating topcoats:

| System | HB1 | VB1 | VB2 |
|---|---|---|---|
| C test (mm) | 0.0 | 5.0 | 0.5 |
| T-bend test | 2.5 | 2.5 | 2.5 |
| Tape test | 1.5 | 1.75 | 0.0 |

1. A method for the corrosion-inhibiting coating of a metal surface, comprising
(1) cleaning the metal surface and optionally treating it with a pretreatment composition, and
(2) coating the cleaned metal surface with a primer (P) comprising
at least one binder (BM),
at least one crosslinking agent (V), and
at least one phosphorus-containing polyester component (A),
wherein (A) is an acidic esterification product of at least one acid selected from the group consisting of phosphonic acid, monophosphoric acid, polyphosphoric acid, mixtures of two or more of the foregoing, the anhydrides thereof, the esters thereof, and mixtures of two or more of the foregoing, with at least one polyester (B) comprising at least two hydroxyl groups, and
(3) drying and/or curing the primer at temperatures of at least 80°.

2. The method of claim 1, wherein the polyester (B) comprises aliphatic dicarboxylic acids and aliphatic dialcohols as molecular units.

3. The method of claim 2, wherein the polyester (B) comprises as molecular units dicarboxylic acids which on the longest carbon chain comprise a carboxyl group in α position and a carboxyl group in ω position.

4. The method of claim 2, wherein the polyester (B) comprises as molecular units dialcohols which on the longest carbon chain comprise a hydroxyl group in α position and a hydroxyl group in ω position.

5. The method of claim 1, wherein the polyester (B) has an OH number per DIN 53240 of 50 to 500 mg KOH/g and/or an acid number per DIN 53402 of less than 20 mg KOH/g.

6. The method of claim 1, wherein the crosslinking agent (V) comprises at least one melamine compound.

7. The method of claim 1, wherein the primer (P) is applied at a wet film thickness such that curing results in a dry film thickness of 1 μm to 15 μm.

8. A method for coating metal coils, comprising
(a) applying a primer (P) by the method of claim 1 to a cleaned and optionally pretreated metal surface of a metal coil,
(b) optionally drying the film formed from the applied primer (P),
(c) applying a topcoat film (D) to the applied primer layer optionally dried in step (b), and
(d) jointly curing the films of applied primer (P) and applied topcoat (D), wherein the primer (P) comprises at least one binder (BM),
at least one crosslinking agent (V), and
at least one phosphorus-containing polyester component (A),
wherein (A) is an acidic esterification product of at least one acid selected from the group consisting of phosphonic acid, monophosphoric acid, polyphosphoric acid, mixtures of two or more of the foregoing, the anhydrides thereof, the esters thereof, and mixtures of two or more of the foregoing, with at least one polyester (B) comprising at least two hydroxyl groups.

9. The method of claim 8, wherein the joint curing of the films of primer (P) and topcoat (D) in step (d) of the method is carried out at peak metal temperatures (PMT) between 150 and 280° C.

10. The method of claim 8, wherein the metal substrate to be coated is selected from the group consisting of iron, steel, zinc, zinc alloys, magnesium, magnesium alloys, aluminum, and aluminum alloys.

11. The method of claim 8 wherein the optional step of drying the primer occurs at temperatures of at least 80° C.

12. A method for coating metal coils, comprising
(a) applying a primer (P) by the method of claim 1 to a cleaned and optionally pretreated metal surface of a metal coil, and
(b) optionally drying and/or curing the film formed from the applied primer (P), wherein primer (P) comprises at least one binder (BM),
at least one crosslinking agent (V), and
at least one phosphorus-containing polyester component (A), herein (A) is an acidic esterification product of at least one acid selected from the group consisting of phosphonic acid, monophosphoric acid, polyphosphoric acid, mixtures of two or more of the foregoing, the anhydrides thereof, the esters thereof, and mixtures of two or more of the foregoing, with at least one polyester (B) comprising at least two hydroxyl groups.

13. The method of claim 12 further comprising
(c) applying a topcoat film (D) to the applied primer layer optionally dried in step (b), and
(d) jointly curing the films of applied primer (P) and applied topcoat (D).
